(19) United States
(12) Patent Application Publication
(10) Pub. No.: US 2003/0110705 A1
(43) Pub. Date: Jun. 19, 2003

(54) Plastic double-walled structural panel

(75) Inventors: Mark C. Hlavach, Putnam Township, MI (US); Gregory J. Schwagle, Westland, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Carlisle Engineered Products

(21) Appl. No.: 10/015,436

(22) Filed: Dec. 13, 2001

(51) Int. Cl. E06B 3/00

(52) U.S. Cl. 49/501

(57) ABSTRACT

The present invention is directed to a plastic double-walled structural panel suitable for use as a door or tailgate for a motor vehicle. The structural panel includes a plastic outer panel, a plastic inner panel, and a substantially plastic support structure. Generally, the plastic outer panel has one or more outer attachment points that correspond to one or more inner attachment points in the inner panel. In a preferred embodiment of the invention, the support structure is comprised of plastic and is formed integrally with the inner or outer panel, e.g., as integral trusses. Integrally-formed or non-integrally-formed connectors may be included for connecting attachment points of the inner panel and attachment points of the outer panel. The invention further includes a method for manufacturing and assembling a substantially plastic double-walled structural panel that is suitable for use in connection with motor vehicles.

### TECHNICAL FIELD

The present invention relates generally to a plastic, double-walled structural panel that is suitable for use with motor vehicles, for instance, such as a door portion or tailgate. The invention includes a method for manufacturing and assembling a plastic, double-walled structural panel.

### BACKGROUND OF THE INVENTION

Multi-walled structural panels, such as those used in connection with motor vehicles, are known in the art. However, conventional structural panels typically include a significant amount of metal. The metal may be used to form complete panels, as separate intermediate reinforcements, or as some combination of the foregoing. With the advancement of manufacturing technologies, there has been a movement in the industry to reduce the amount of time, weight and cost associated with the construction of such panels, for example, by utilizing components with increased amounts of plastic material.

For those and other reasons, there exists a need in the industry for an improved double-walled structural panel suitable for motor vehicles that is comprised primarily of non-metal materials, such as plastics, particularly one that can be produced in a cost effective, efficient and reliable manner.

### SUMMARY OF THE INVENTION

Accordingly, the present invention is directed to a plastic double-walled structural panel that is suitable for use as a door or tailgate for a motor vehicle. The structural panel includes a substantially plastic outer panel, plastic inner panel, and plastic support structure. Generally, the plastic outer panel has one or more outer attachment points that correspond to one or more inner attachment points on the inner panel.

In a preferred embodiment of the present invention, the support structure is comprised of plastic and is formed integrally with the inner panel or outer panel, such as integral trusses. Integrally-formed or non-integrally-formed connectors may be included for connecting one or more attachment points of the inner panel and attachment points of the outer panel. The present invention further includes a method for manufacturing and assembling a substantially plastic double-walled structural panel that is suitable for use in connection with motor vehicles.

### BRIEF DESCRIPTION OF THE DRAWINGS

FIG. 1 is a perspective view of a structural panel of an embodiment of the present invention shown with the inner and outer panels separated.

FIG. 2 illustrates an embodiment of the present invention, similar to that shown in FIG. 1, but shown from a different perspective.

FIG. 3 is front elevation view of an embodiment of the inner panel.

FIG. 4 is a breakaway perspective view of an inner panel.

FIG. 5 is a front elevation view of an embodiment of a bracket.

FIG. 6 is a perspective view illustrating the connection of a bracket to the inner panel.

FIG. 7 is top plan section view of a preferred connection of the inner and outer panels.

FIG. 8 is a top plan section view of another embodiment of the connection of the inner and outer panels.

FIG. 9 is a perspective view of another embodiment of the present invention.

FIG. 10 is a perspective view illustrating yet another aspect of the present invention.

FIG. 11 is an illustration of the invention used on a vehicle in the context of a door.

### DETAILED DESCRIPTION OF THE PREFERRED EMBODIMENTS

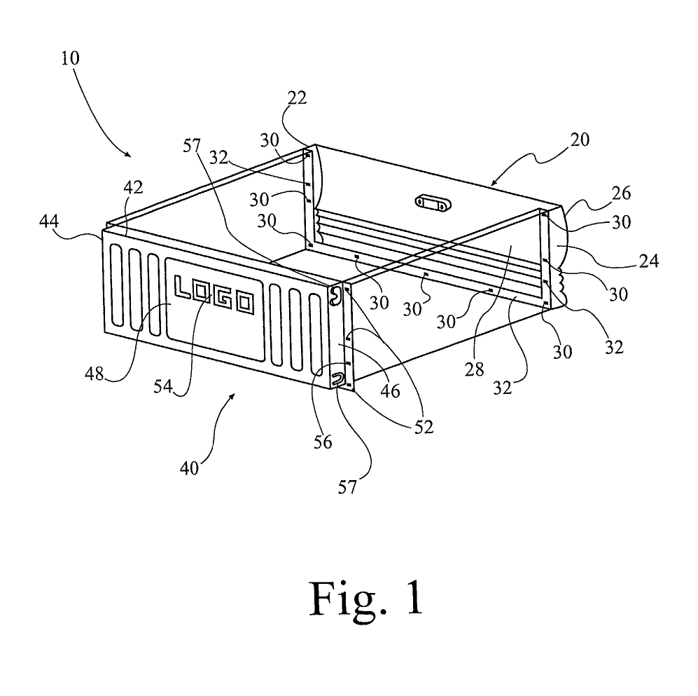

Referring to the drawings, an embodiment of a plastic double-walled structural panel 10 is illustrated in FIG. 1 with separated panels. The structural panel 10 is comprised of “double walls,” i.e., at least an outer panel 20 and an inner panel 40. Preferably, both panels 20,40 are comprised of a plastic, although not necessarily the same plastic. Some examples of suitable plastics that may be used in the formation of the panels 20,40 include, without limitation, thermoplastics designed for injection molding, compression molding, blow molding, extrusion molding, or thermoforming, e.g., polypropylene and glass-filled polypropylene. Some additional blends of plastics that may also be used to form the panels include blends comprised of polycarbonate and polybutylene terephthalate (PC-PBT), polycarbonate and acrylonitrile butadiene styrene (PC-ABS), and polyphenylene ether and polyamide (PPE-PA).

If desired, one or both of the panels 20,40 may be formed from mold-then-paint plastic resin materials or from paint-filmed plastics, such as paint-film thermal plastic olefins (TPOs). Moreover, the panels 20,40 may additionally include other integrally-formed, non-plastic material components. For instance, metal finishing inserts or item of attachment hardware can be included during the formation of one or both panels.

The outer panel 20 includes first and second longitudinal ends 22,24, an outer appearance surface 26 (not directly visible in FIG. 1), an inner surface 28, and one or more outer attachment points 30. Depending upon the application, the outer panel 20 may include one or more continuous or non-continuous attachment flanges or attachment surfaces 32, which in turn may each include one or more outer attachment points 30. While not a requirement, in a preferred embodiment the outer panel 20 is formed as a unitary or single-piece article by molding (e.g., injection molding, compression molding, or blow molding) a plastic material.

In the aforementioned embodiment, the plastic inner panel 40 has a top portion 42, first and second longitudinal ends 44,46, an inner appearance surface 48, a support structure 50 (not directly visible in FIG. 1), and a plurality of inner attachment points 52 that correspond to one or more of the outer attachment points 30. The inner panel 40 may further include one or more ornamental features 54, usually on the inner appearance surface 48. Such features may include, without limitation, designs, logos, panels, or virtually any other form of ornamental formation that does not compromise the necessary strength and function of the panel.

In a preferred embodiment, the inner panel 40 includes continuous or non-continuous flanges or connection surfaces 56, which are generally in proximity to the first and second longitudinal ends 44, 46 and are designed to mate with, abut or engage portions of the outer panel 20. The surfaces 56 preferably include one or more inner attachment points 52, which are preferably provided on a substantially flat mating surface with respect to corresponding attachment points 30 on outer panel 20.

Depending upon the application for the panel 10, the inner panel 40 may further include various types of hinges, latches, locks, straps, cables, wires, clips, straps, hooks, lighting equipment or other forms of functional hardware. While such components may be specifically and individually identified, they may be collectively referred to as “hardware” and generally designated as items 57 in FIG. 1.

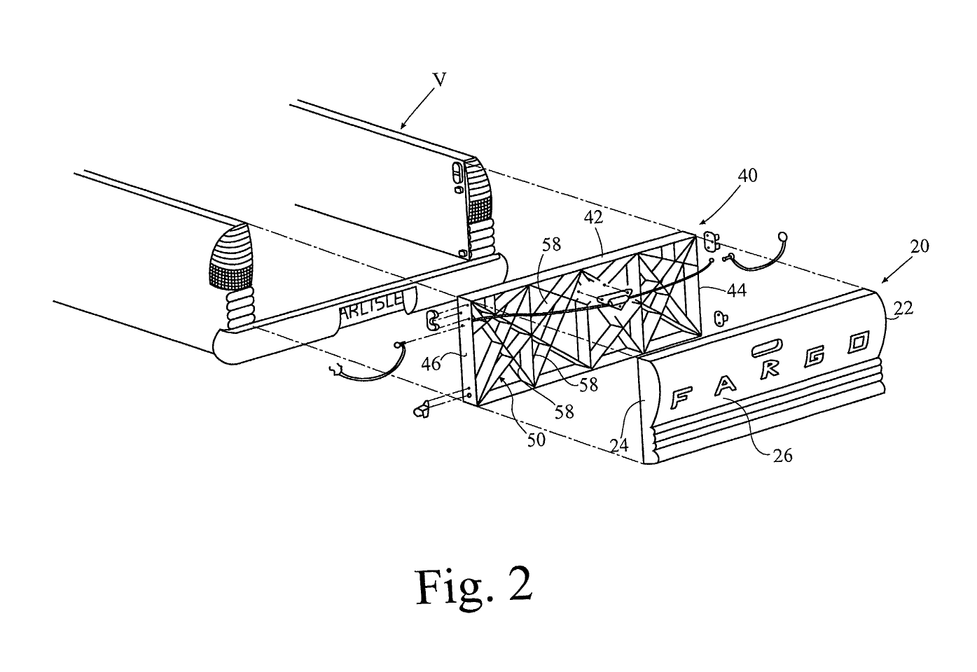

Turning to FIG. 2, an embodiment of the invention is shown from a different perspective and again in the context of a tailgate for a motor vehicle V. As illustrated, support structure 50 is preferably formed integrally as a single unit and, more preferably, integrally with the inner panel 40 (or, alternatively, the outer panel 20), such as a single molded piece. However, the invention also contemplates the substitution or additional inclusion of one or more plastic support structures that may be formed separately from the inner panel 40 and incorporated into the panel 10 to serve similar functions.

Preferably, the support structure 50 is predominantly (i.e., more than one-half) or completely comprised of plastic and includes one or more vertical or angled trusses, structural reinforcements, or other form of supports 58, which may collectively be referred to as “supports” or “inner supports.” Supports 58 can be specifically designed (for example, by using finite element analysis methodologies) to fit in the available space and to provide additional structural strength and/or physical integrity for the space defined between the appearance surfaces of the outer and inner panels 20,40. Whether integrally formed or not, the supports 58 can be configured to provide sufficient strength to the panel 10 against forces that may be encountered from several primary directions, such as perpendicular to the plane generally formed by the inner appearance surface 48.

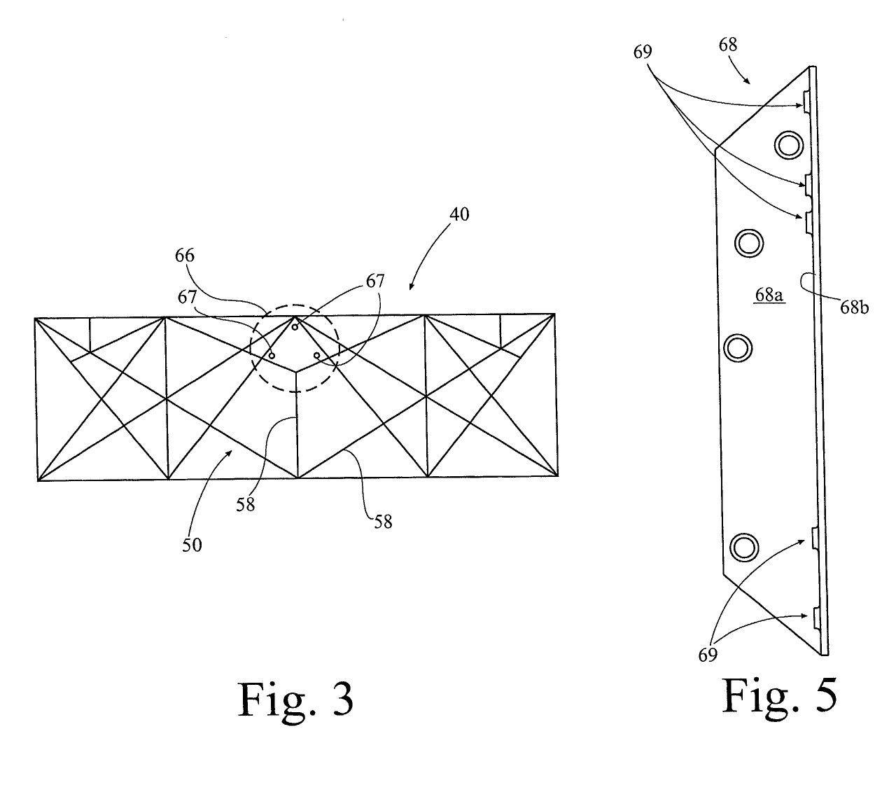

As shown in FIG. 3, the inner supports 58 of the support structure 50 can be designed to provide space for the inclusion and/or attachment of hardware for a desired application. Spaces formed between supports 58 and/or the walls of the inner panel 40 can form a plurality of attachment zones 66 for attachment features 67, such as bolt holes, and may form compartments for hardware and other articles, such as storage items.

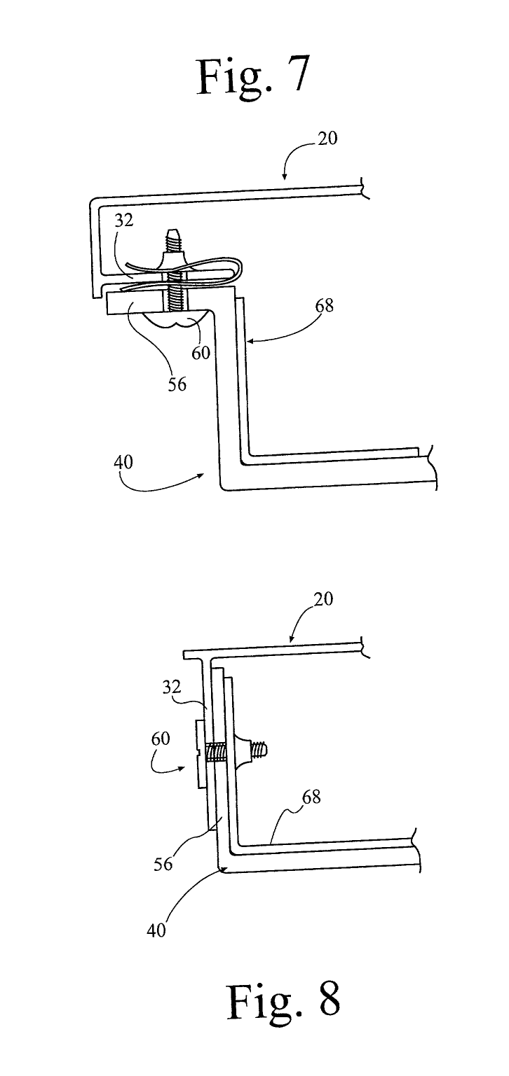

Also in a preferred embodiment, such as shown in FIGS. 7 and 8, connectors 60 are used to connect inner attachment points 52 of the inner panel 40 and the attachment positions 30 of the outer panel 20. Preferably, the connectors include bolts or screws. However, other forms of fasteners and conventional connection devices may also be used as connectors 60. In a preferred embodiment, the method of connection will be “low profile” or hidden when the panel 10 is assembled for use and will permit a user to more efficiently remove and repair or replace the outer panel 20. In an alternative embodiment, one or more of the connectors 60 can be integrally molded formations such as latches, hooks, pegs, or other formations formed in the outer or inner panels 20,40 at one or more of their respective outer and/or inner attachment points 30, 52.

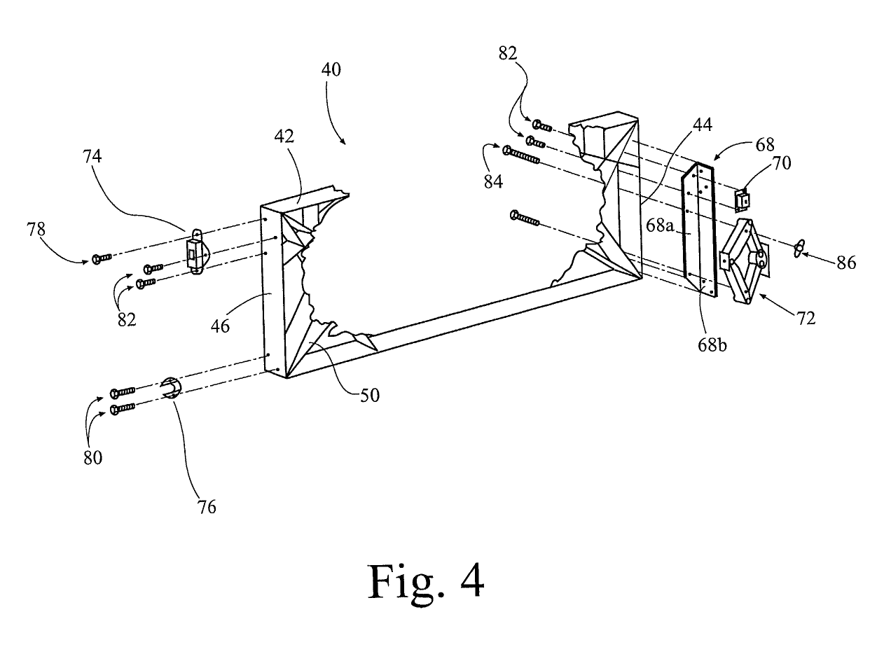

FIG. 4 includes an embodiment of the inner panel 40 having broken away sections at ends 44,46 to better illustrate an example of a preferred method for attaching connection items and hardware to the inner panel 40. While not a requirement, preferably, one or more plastic or metal brackets, such as an L-bracket 68 (shown) or K-bracket, may be used to connect to the inner panel 40 and/or various items of hardware.

Turning to FIG. 5, an independent view of a preferred bracket 68 with threaded holes 69 is illustrated. However, it should be noted that the invention is not limited to a specific form of bracket, and numerous other brackets of various shapes and sizes (both with and without threaded holes) are also contemplated by the invention.

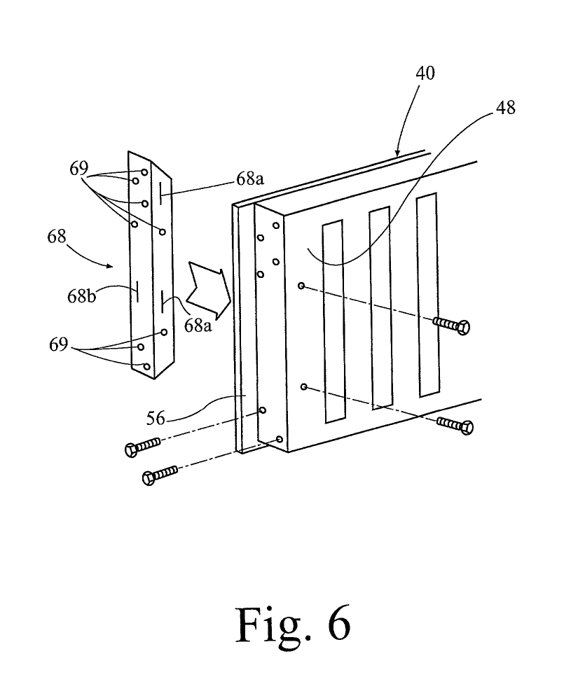

If an L-bracket is used, preferably, one side of the bracket 68a is connected to the inner appearance surface 48 of the inner panel 40 while the other side of the bracket 68b is connected to the longitudinal end 44 of the inner panel 40. The configuration allows varies items of hardware, for example and without limitation, a panel latch 70, a jack 72, a tailgate latch 74 or a hinge cup 76, to be connected to the bracket 68. The hardware and the bracket 68 can be connected to the inner panel 40 and/or the support structure 50 using various forms of screws, bolts, or other fasteners for instance, stay bolts 78, hinge bolts 80, panel latch bolts 82, and studs 84 with wing nuts 86. FIG. 6 further illustrates the assembly of a preferred version of a bracket 68 to the inner panel 40. If desired, the bracket 68 may include weld nuts or pierced holes to receive hardware connectors or fasteners.

While numerous specific structural attachment configurations are possible and are contemplated by the present invention, a preferred method of connecting the outer panel and inner panel is depicted in FIG. 7. As illustrated, attachment surface 32 of the outer panel 20 is connected to or mated with corresponding connection surface 56 of the inner panel 40. Connector 60 may include a machine screw and a J-nut and the zone of contact of the respective surfaces 32, 56 in proximity to the attachment points 30, 52 is preferably substantially parallel and flush. If desired, a bracket 68 may be attached to the inner panel 40 at hardware locations and anti-rattle bumpers.

Another example of a connection configuration for connecting the outer panel 20 and inner panel 40 is shown in FIG. 8. In this embodiment, the orientation of the connector 60 is rotated (as compared to FIG. 7) and bracket 68 is also connected with the panels 20, 40. For example, but without limiting the present invention, such a “triple-connection” can be accomplished by passing a screw (such as a machine screw) through the outer and inner panels and into a pierced hole in the bracket 68.

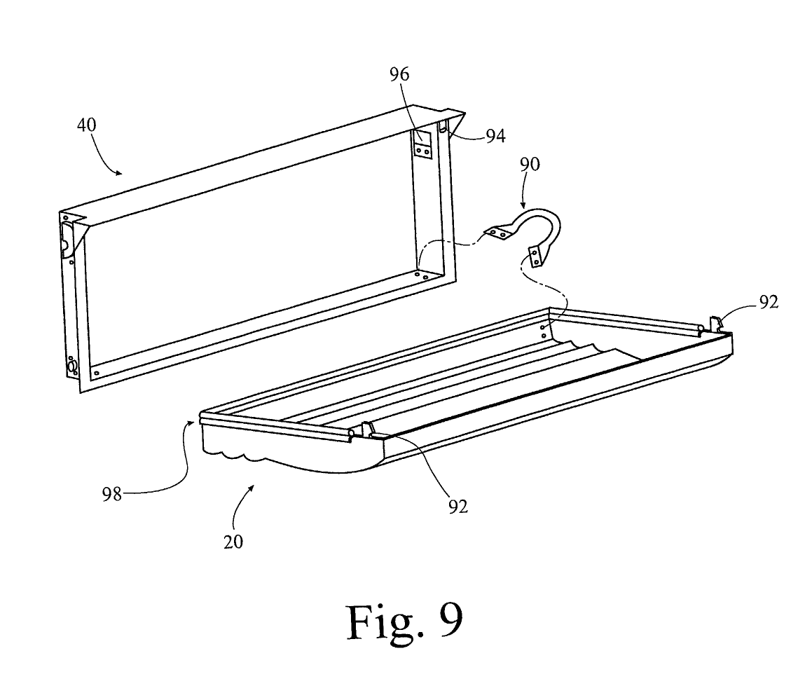

FIG. 9 illustrates an embodiment of the structural panel 10 in which support structure 50 is either removed (for purpose of the instant figure) or is not formed integrally with the inner panel 40. A hinge 90 is used to connect the inner panel 40 to the outer panel 20 and to permit controlled opening. In a preferred embodiment, one or more hinges 90 are positioned on the bottom of the respective panels 20,40 to permit the outer panel 20 to swing downwardly and permit access to the space within the inner panel 40. Alternative configurations may permit the hinge or hinges 90 to be positioned along the sides or top of the inner panel 20 to permit the outer panel 40 to open about a different axis. In some cases, the hinge 90 configuration selected is dependent upon the associated body structure, e.g., tailgate and bumper styling.

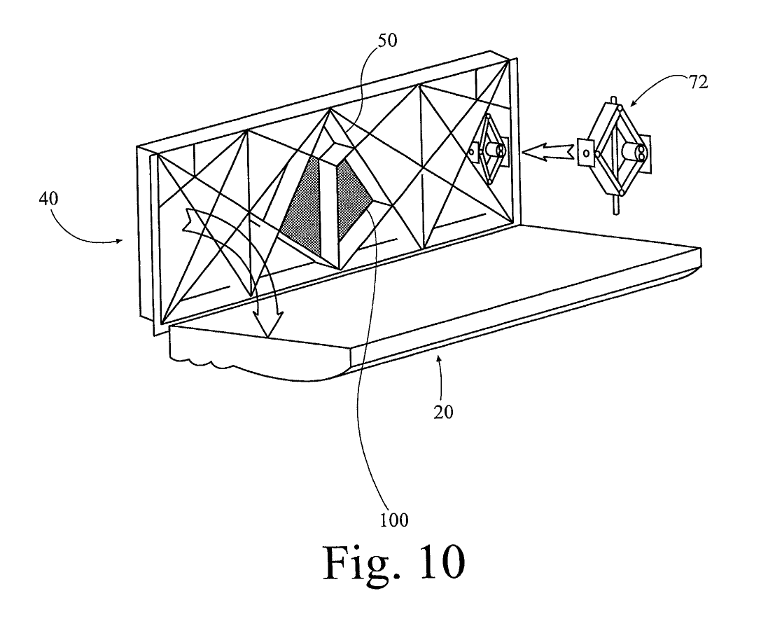

Preferably, the outer panel 20 includes connection formations 92 retained by retaining grooves or formations 94 associated a panel latch 96. The panel latch 96 can be separate (e.g., for optional installations) or can be integral with the tailgate latch if opening of the outer panel 20 is a “standard” feature. If desired, a seal 98 (e.g., bulb seal) can be included—to seal all or a portion of the “gap” or parting line between the panels 20, 40 when the panels are connected to provide improved weatherproofing, sound and vibration damping. Further, cavities 100 with “free” space (i.e., space not dedicated to other functions), such as shown in FIG. 10, may be used to hold or retain additional items or equipment, such as tow straps, tie downs, jumper cables, and the like.

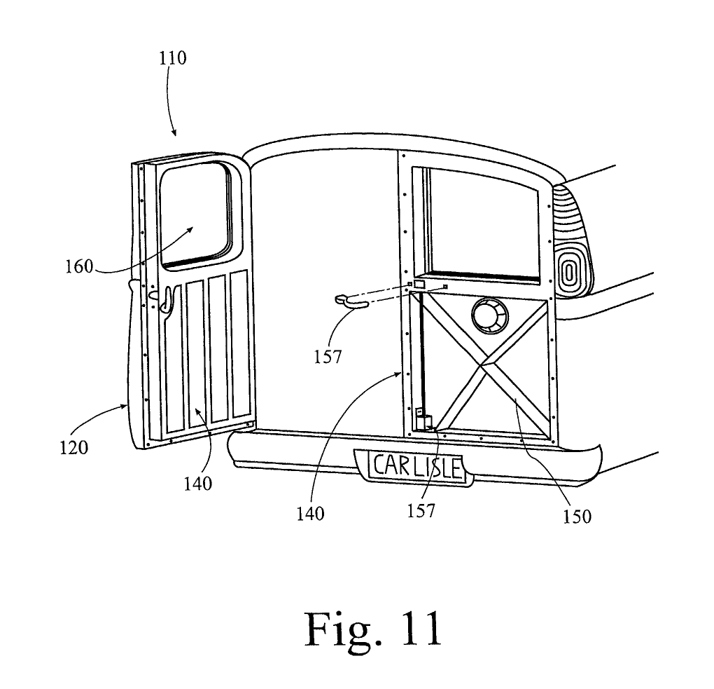

Yet another embodiment of the invention - in the context of a vehicle door is generally illustrated in FIG. 11. In a similar fashion to previous embodiments, the structural panel 110 includes an outer panel 120 connected to an inner panel 140. The structural panel 110 may further include an inner support structure 150. Like prior embodiments, the support structure may be separately or integrally formed with the inner panel 140 (or, alternatively, the outer panel 120), but is preferably formed integrally with the panel 140.

The outer panel 120 may be single-piece (such as for panel vans without windows) or two-piece or multi-piece (such as where the outer panel include one or more openings or windows 160—e.g., as illustrated in FIG. 11). In either case, the same inner structure, including inner panel 140, may be used. Preferably, if a glass or plastic window 160 is used, it will be circumferentially retained or glued in place, or it may be optionally hinged in place for ventilation.

Inner panel 140 (shown to the right in FIG. 11) illustrated the panel with support structure 150 in place and certain door hardware 157 installed or lined up for installation. Preferably, the door hardware is installed and adjusted for proper operation prior to the assembly of the outer panel 120. Once the inner panel 140 and hardware 157 is properly assembled, the outer panel 120 can be adjusted and fit to the structure without significantly affecting the door operation.

While exemplary embodiments of this invention have been described in detail above, such disclosure is by way of illustration and not limitation. Those skilled in the art will readily appreciate that many modifications are possible in the exemplary embodiments, as shown and/or described above, without materially departing from the novel teachings and advantages of this invention. Accordingly, all such modifications are intended to be included within the scope of this invention as defined in the following claims, which should be construed as broadly as the prior art will permit.

What is claimed is:

1. A plastic double-walled structural panel suitable for a vehicle, comprising:
an outer panel comprised of plastic and having a top portion, first and second longitudinal ends, an outer appearance surface, an inner surface, and one or more outer attachment points;
an inner panel comprised of plastic and having a top portion, first and second longitudinal ends, an inner appearance surface, and one or more inner attachment points corresponding to an outer attachment point;
a support structure comprised of plastic that is positioned between the inner and outer panel; and
at least one connector for connecting one or more inner attachment points and one or more outer attachment points.

2. A structural panel as recited in claim 1, wherein the support structure is formed integrally with the inner panel or the outer panel.

3. A structural panel as recited in claim 2, wherein the support structure extends longitudinally substantially from the first longitudinal end to the second longitudinal end of the inner panel.

4. A structural panel as recited in claim 1, wherein the support structure includes integral inner supports.

5. A structural panel as recited in claim 4, wherein the inner supports extend forward from the appearance surface of the inner panel and form a plurality of compartments.

6. A structural panel as recited in claim 1, including a hardware bracket connected to the inner panel at a hardware attachment point.

7. A structural panel as recited in claim 6, wherein the hardware bracket is L-shaped or K-shaped and is connected to the inner panel.

8. A structural panel as recited in claim 1, wherein the connectors are integrally formed at the inner attachment point of the inner panel or at the outer attachment point of the outer panel and such connectors mate with corresponding features in the opposing panel.

9. A structural panel as recited in claim 8, wherein the corresponding features in the opposing panel includes apertures, slots, grooves, hooks, or flanges.

10. A structural panel as recited in claim 1, wherein the connectors include bolts, screws, clips, or pins for connecting the inner panel and the outer panel.

11. A structural panel as recited in claim 1, including hardware connected to the inner panel.

12. A structural panel as recited in claim 11, wherein the hardware includes hinges, latches, locks, straps, cables, wires, clips, hooks, or lighting equipment.

13. A structural panel as recited in claim 1, wherein the outer panel is injection molded, blow molded, vacuum formed, or compression molded.

14. A structural panel as recited in claim 1, wherein the inner panel is injection molded, compression molded, blow molded, extrusion molded, or thermoformed.

15. A structural panel as recited in claim 1, wherein the outer appearance surface of the outer panel or the inner appearance surface of the inner panel is comprised of high-impact and corrosion-resistant thermoplastic.

16. A structural panel as recited in claim 1, wherein, when assembled, the top portion of the inner panel covers the top portion of the outer panel.

17. A structural panel as recited in claim 1, wherein, when assembled, the outer panel is positioned over the top portion of the inner panel.

18. A structural panel as recited in claim 1, wherein the inner panel and the outer panel are hinged.

19. A structural panel as recited in claim 1, wherein the inner panel and the outer panel form at least one compartment.

20. A structural panel as recited in claim 1, wherein the outer panel includes at least one window.

21. A plastic double-walled structural panel suitable for a vehicle, comprising:
an outer panel comprised of plastic and having a top portion, first and second longitudinal ends, an outer appearance surface, an inner surface, and one or more outer attachment points;
an inner panel comprised of plastic and having first and second longitudinal ends, an inner appearance surface, a support structure formed integrally with the inner panel, and inner attachment points corresponding to one or more outer attachment points of the outer panel;
a hardware bracket connected to the inner panel; and
at least one connector for connecting at least one inner attachment point of the inner panel and at least one corresponding outer attachment point of the outer panel.

22. A method for forming a plastic double-walled structural panel suitable for a vehicle, comprising:
molding a plastic outer panel having a top portion, first and second longitudinal ends, an outer appearance surface, an inner surface, and one or more outer attachment points;
molding a plastic inner panel having first and second longitudinal ends, an inner appearance surface, a support structure, and one or more inner attachment points corresponding to one or more outer attachment points of the outer panel; and
connecting one or more inner attachment points of the inner panel and one or more outer attachment points of the outer panel.

23. A method as recited in claim 22, including the step of installing hardware prior to completing the connection of the outer panel to the inner panel.

24. A method as recited in claim 22, including the step of installing equipment between the outer and inner panels prior to completing the connection of the outer panel to the inner panel.

25. A method for forming a plastic double-walled structural panel suitable for a vehicle, comprising:
molding a plastic outer panel having a top portion, first and second longitudinal ends, an outer appearance surface, an inner surface, a support structure, and one or more outer attachment points;
molding a plastic inner panel having first and second longitudinal ends, an inner appearance surface, and one or more inner attachment points corresponding to one or more outer attachment points of the outer panel; and
connecting one or more inner attachment points of the inner panel and one or more outer attachment points of the outer panel.

26. A method for forming a plastic double-walled structural panel suitable for a vehicle, comprising:
molding a plastic outer panel having a top portion, first and second longitudinal ends, an outer appearance surface, an inner surface, and one or more outer attachment points;
molding a plastic inner panel having first and second longitudinal ends, an inner appearance surface, and one or more inner attachment points corresponding to one or more outer attachment points of the outer panel;
molding a separate plastic support structure;
positioning the support structure between the inner and outer panels; and
connecting at least one inner attachment point of the inner panel and at least one outer attachment point of the outer panel.

27. A method as recited in claim 26, including the step of installing hardware prior to the complete connection of the outer panel and inner panel.

28. A method as recited in claim 26, wherein at least one article of hardware is connected to the support structure prior to the connection of the support structure to the inner panel.
